(19) United States
(12) Patent Application Publication
(10) Pub. No.: US 2025/0097290 A1
(43) Pub. Date: Mar. 20, 2025

(54) DATA PIPELINE ORCHESTRATION FOR DATA-DRIVEN ENGINEERING

(71) Applicant: SAP SE, Walldorf (DE)

(72) Inventors: Fabian ARNDT, Nördlingen (DE); Enes OERDEK, Schwetzingen (DE)

(21) Appl. No.: 18/470,724

(22) Filed: Sep. 20, 2023

(51) Int. Cl. H04L 67/1095

(52) U.S. Cl. CPC H04L 67/1095

(57) ABSTRACT

A system associated with data pipeline orchestration may include a data pipeline data store that contains, for each of a plurality of data pipelines, a series of data pipeline steps associated with a data pipeline use case. A data pipeline orchestration server may receive, from a data engineering operator, a selection of a data pipeline use case in the data pipeline data store. The data pipeline orchestration server may also receive first configuration information for the selected data pipeline use case and second configuration information, different than the first configuration information, for the selected data pipeline use case. The data pipeline orchestration server may then store representations of both the first configuration information and the second configuration information in connection with the selected data pipeline use case. Execution of the selected pipeline is then arranged in accordance with one of the first configuration information and the second configuration information.

### BACKGROUND

An enterprise may use distributed cloud services to perform business functions. For example, the cloud services may store documents, implement processes, interface with customers, etc. The enterprise may utilize data engineers who design and build systems that collect and analyze raw data from multiple sources and formats (e.g., to help find practical applications of the data). As used herein, the phrase “data engineering” may refer to any systems that enable the collection and usage of data allowing for subsequent analysis and data science (e.g., using machine learning). Making the data usable may involve, for example, substantial compute and storage tasks as well as data processing and cleaning. To facilitate such work, a data pipeline might be used, for example, to collect raw data, process the data, and generate a dashboard visualization. Manually creating such a data pipeline from scratch for a particular use case can be a time consuming and error prone task-especially when a substantial amount of data and/or multiple data engineering teams are involved. Note that as used herein, “engineers” or “engineering teams” may refer to application developers, who are often not “data engineers.” Engineers may use the contents of data engineers or data scientists to implement data driven engineering in their daily business.

It would therefore be desirable to provide improved and efficient implementation of data pipelines, such as those associated with data engineering analytics for a cloud services system, in a fast, automatic, and accurate manner.

### SUMMARY

According to some embodiments, a system associated with data pipeline orchestration may include a data pipeline data store that contains, for each of a plurality of data pipelines, a series of data pipeline steps associated with a data pipeline use case. A data pipeline orchestration server may receive, from a data engineering operator, a selection of a data pipeline use case in the data pipeline data store. The data pipeline orchestration server may also receive first configuration information for the selected data pipeline use case and second configuration information, different than the first configuration information, for the selected data pipeline use case. The data pipeline orchestration server may then store representations of both the first configuration information and the second configuration information in connection with the selected data pipeline use case. Execution of the selected pipeline is then arranged in accordance with one of the first configuration information and the second configuration information.

Some embodiments comprise: means for receiving, at a computer processor of a data pipeline orchestration server from a data engineering operator, a selection of a data pipeline use case in a data pipeline data store, wherein the data pipeline data store contains, for each of a plurality of data pipelines, a series of data pipeline steps associated with a data pipeline use case; means for receiving first configuration information for the selected data pipeline use case; means for receiving second configuration information, different than the first configuration information, for the selected data pipeline use case; means for storing representations of both the first configuration information and the second configuration information in connection with the selected data pipeline use case; and means for arranging for execution of the selected pipeline in accordance with one of the first configuration information and the second configuration information.

Some technical advantages of some embodiments disclosed herein are systems and methods to provide improved and efficient implementation of data pipelines use cases for cloud services in a fast, automatic, and accurate manner.

### BRIEF DESCRIPTION OF THE DRAWINGS

FIG. 1 is a data engineering information flow.

FIG. 2 illustrates a cross industry standard process for data mining technique.

FIG. 3A is an example of a data pipeline.

FIG. 3B is an example of a data engineering visualization.

FIG. 4 is a high-level system architecture in accordance with some embodiments.

FIG. 5 is a method according to some embodiments.

FIG. 6 shows some data pipeline scalability in accordance with some embodiments.

FIG. 7 is a data pipeline orchestration service display according to some embodiments.

FIG. 8 is a data pipeline orchestration service use case display in accordance with some embodiments.

FIG. 9 is a data pipeline orchestration service display according to some embodiments.

FIG. 10 is a data pipeline orchestration service configuration display in accordance with some embodiments.

FIG. 11 illustrates a data pipeline hierarchy according to some embodiments.

FIG. 12 is an apparatus or platform according to some embodiments.

FIG. 13 is a tabular portion of a data pipeline data store in accordance with some embodiments.

FIG. 14 is a data pipeline orchestration operator display according to some embodiments.

FIG. 15 illustrates a tablet computer in accordance with some embodiments.

### DETAILED DESCRIPTION

In the following detailed description, numerous specific details are set forth to provide a thorough understanding of embodiments. However, it will be understood by those of ordinary skill in the art that the embodiments may be practiced without these specific details. In other instances, well-known methods, procedures, components, and circuits have not been described in detail so as not to obscure the embodiments.

One or more specific embodiments of the present invention will be described below. To provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

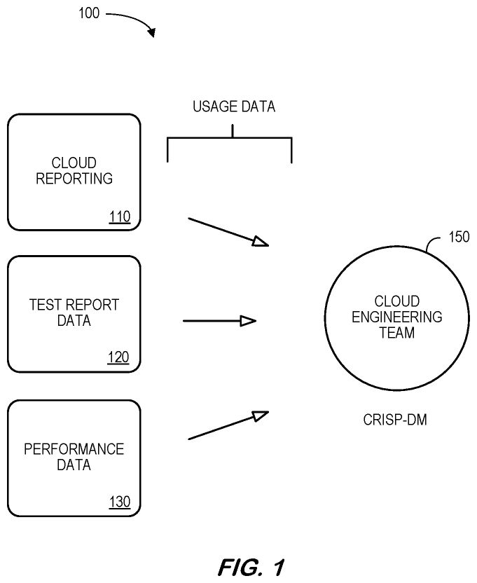

FIG. 1 is a data engineering information flow 100. A cloud engineering team 150 may represent, for example, a data engineering team in the SAP® S/4HANA public cloud or similar system. The team 150 may collect usage data, including cloud reporting 110, test report data 120, and performance data 130 to apply data-driven engineering as part of its daily work. Goals of the team 150 may include improved development and innovation, quality assurance and control, data maintenance, informed decision making, software quality, and customer support.

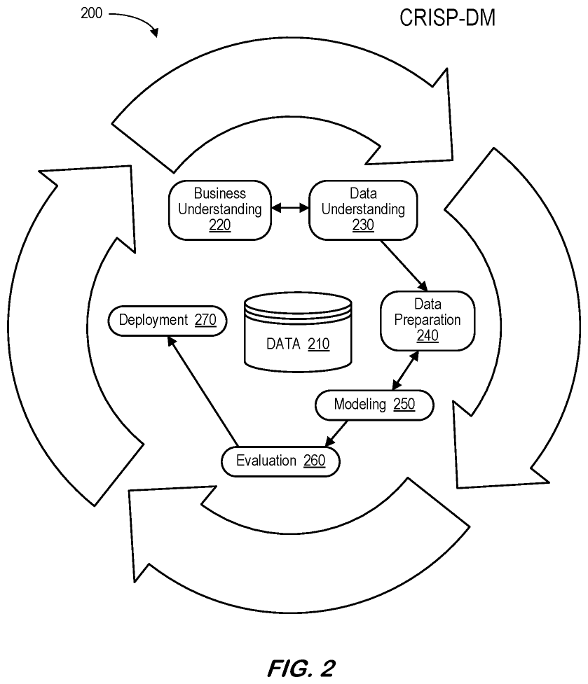

The analysis of usage data may consider: how customers use an Application Programming Interface (“API”), whether test scenarios cover customer reality, support enterprise prioritization and decision making, support ticket handling, find performance issues, etc. According to some embodiments, the team 150 uses a standard process for data mining to analyze the usage data, such as the Cross Industry Standard Process for Data Mining (“CRISP-DM”). FIG. 2 illustrates a Cross Industry Standard Process for Data Mining (“CRISP-DM”) technique 200. The technique 200 or methodology applies business understanding 220 to data 210 to facilitate data understanding 230. A combination of data preparation 240 (e.g., JUPYTER®) and modeling 250 may then be interactively applied and the results may undergo evaluation 260. In some cases, the evaluation 260 may be fed back to the business understanding 220 if appropriate. After the evaluation 260 is successful, deployment 270 may be performed for the developed system (e.g., a dashboard or infographics may be deployed).

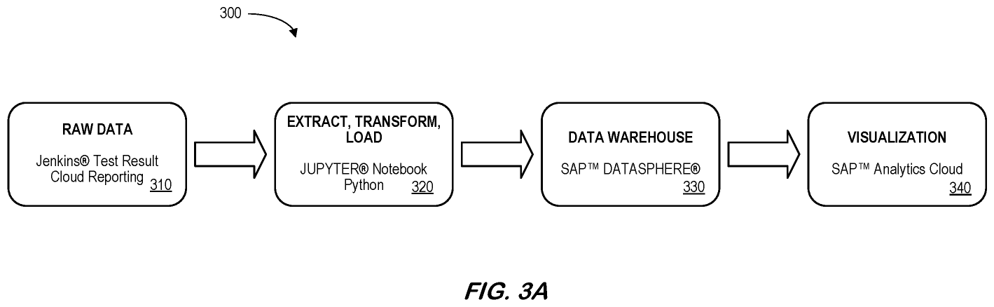

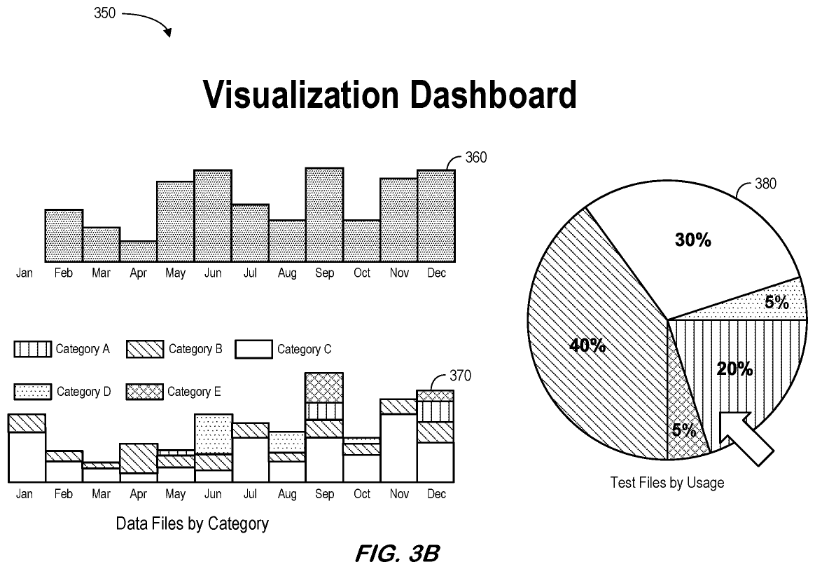

As part of the CRISP-DM technique, a data pipeline may be used to automate some or all of the process. For example, FIG. 3A is a simple example of a data pipeline 300. After raw data 310 is determined (e.g., via JENKINS® test results or cloud reporting), Extract, Transform, Load (“ETL”) 320 tasks may be performed for further processing (e.g., via JUPYTER® notebook or Python code). The result of the tasks may then be pushed or uploaded to a cloud-based data warehouse 330 (such as the SAP™ DATASPHERE®) where further enriching, merging, and cleanup can be performed to enhance the data before it is used to generate a visualization 340 (e.g., via SAP™ Cloud Analytics) for daily data engineering activities and provide value for enterprise activities. For example, FIG. 3B is one example of a data engineering visualization 350 including various graphical charts 360, 370, 380. The data engineering visualization 350 may be associated with, for example, an OPENSEARCH dashboard.

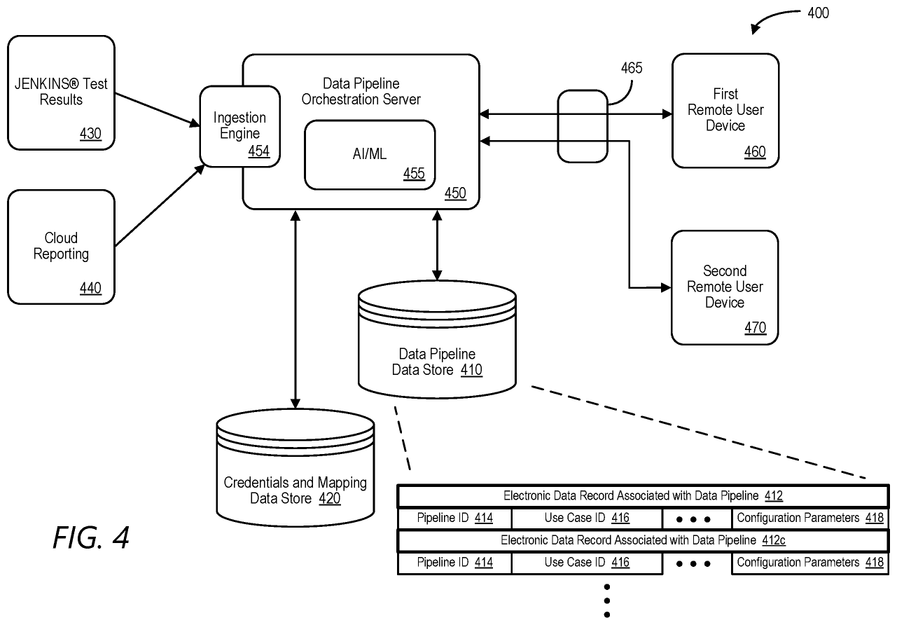

To provide improved and efficient implementation of data pipelines for cloud services in a fast, automatic, and accurate manner, FIG. 4 is a high-level system 400 architecture in accordance with some embodiments. The system 400 includes a data pipeline orchestration server 450. As used herein, devices, including those associated with the system 400 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described in accordance with various embodiments herein may communicate via one or more such communication networks.

The data pipeline orchestration server 450 may store information into and/or retrieve information from various data stores such as a data pipeline data store 410 (e.g., containing electronic records 412 with a pipeline identifier 414, a use case identifier 416, configuration parameters 418, etc.) and a credentials and mapping data store 420, which may be locally stored or reside remote from the data pipeline orchestration server 450. Although a single data pipeline orchestration server 450 is shown in FIG. 4, any number of such devices may be included. Moreover, various devices described herein might be combined according to embodiments of the present invention. For example, in some embodiments, the data pipeline orchestration server 450 and data pipeline data store 410 might comprise a single apparatus.

The data pipeline orchestration server may receive JENKINS® test results 430 and cloud reporting 440 via an ingestion engine 454 and use Artificial Intelligence (“AI”) and/or Machine Learning (“ML”) 455 to analyze the information. The data pipeline orchestration server 450 may communicate with a first remote user device 460 and a second remote user device 470 via a firewall 465 (e.g., associated with different data engineering teams within an enterprise. The system 400 functions may be automated and/or performed by a constellation of networked apparatuses, such as in a distributed processing or cloud-based architecture. As used herein, the term “automated” may refer to any process or method that may be performed with little or no human intervention.

An operator, administrator, or enterprise application may access the system 400 via a remote device (e.g., a Personal Computer (“PC”), tablet, or smartphone) to view information about and/or manage operational information in accordance with any of the embodiments described herein. In some cases, an interactive graphical user interface display may let an operator or administrator define and/or adjust certain parameters (e.g., to implement various mappings or configuration parameters) and/or provide or receive automatically generated results (e.g., reports and alerts) from the system 400.

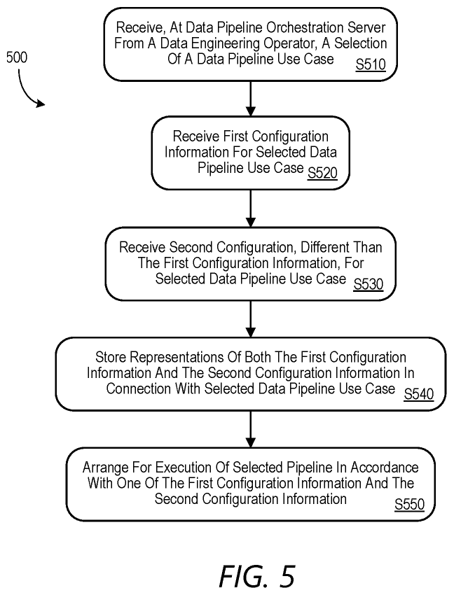

FIG. 5 is a method 500 that might be performed by some, or all, of the elements of any embodiment described herein. The flow charts described herein do not imply a fixed order to the steps, and embodiments of the present invention may be practiced in any order that is practicable. Note that any of the methods described herein may be performed by hardware, software, an automated script of commands, or any combination of these approaches. For example, a computer-readable storage medium may store thereon instructions that when executed by a machine result in performance according to any of the embodiments described herein.

At S510, a computer processor of a data pipeline orchestration server may receive, from a data engineering operator, a selection of a data pipeline use case in a data pipeline data store. The data pipeline data store may contain, for each of a plurality of data pipelines, a series of data pipeline steps or actions associated with a data pipeline use case. At least one of the series of data pipeline steps might be associated with, for example, downloading raw data from an internal enterprise data source, ETL tasks or tools, storing information in a cloud-based data warehouse, a visualization dashboard, data cleanup, data processing, deployment of a structure, data uploading, etc.

At S520, first configuration information is received for the selected data pipeline use case and second configuration information (different than the first configuration information) for the selected data pipeline use case at S530. The configuration information might include, for example, information associated with credentials (e.g., to provide data security for an enterprise), data sources, configuration of further calculations, etc.

At S540, the system may store representations of both the first configuration information and the second configuration information in connection with the selected data pipeline use case. At S550, execution of the selected pipeline is arranged in accordance with one of the first configuration information and the second configuration information. Execution of the selected pipeline may, according to some embodiments, be further performed in accordance with data pipeline scheduler information (e.g., defining when a use case should be deployed).

According to some embodiments, a data pipeline use case associated with one data engineering team of an enterprise is shared with another data engineering team of the enterprise. For example, the data pipeline use case may be shared via a platform and cloud-based service for software development and version control such as GITHUB®. In some embodiments, the data pipeline use case is deployed to a development system, a test system, a production system, etc.

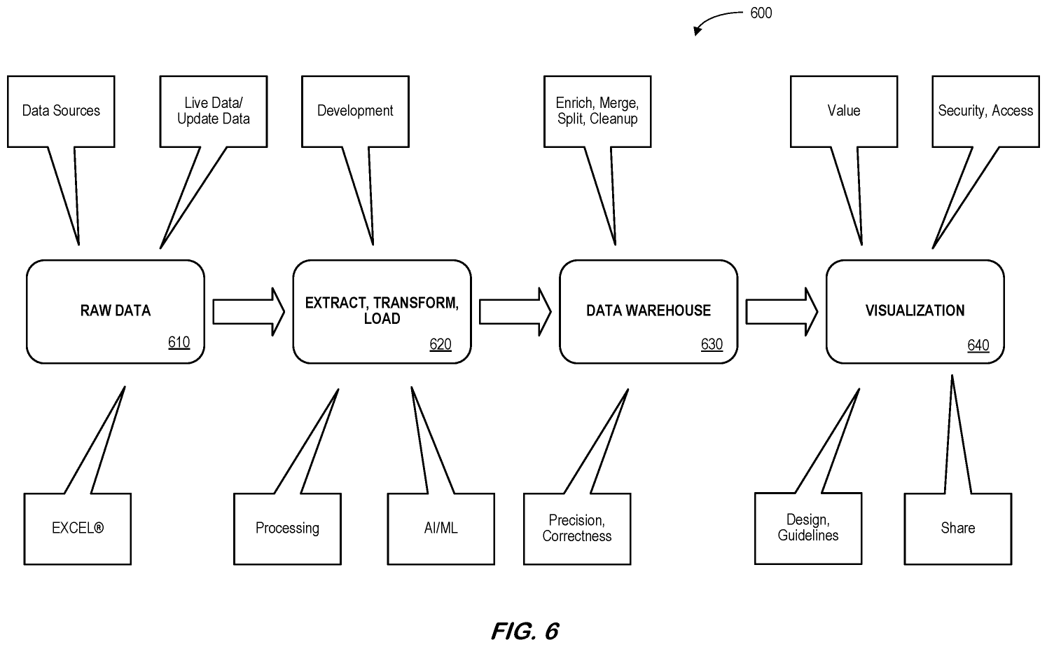

Scaling such an approach across an enterprise and taking into account other considerations when building a data pipeline or analytics use case can be a difficult task. For example, FIG. 6 shows some data pipeline issues 600 in accordance with some embodiments. Initially, raw data 610 may include various data sources, live data, data that needs to be updated, spreadsheet application data (e.g., a MICROSOFT™ EXCEL® file), etc. ETL 620 tasks may need to take into account development considerations, processing, AI and ML applications, etc. A push to a data warehouse 630 might include steps to enrich, merge, split, cleanup data, etc. and may need to take into account precision and correctness concerns. Finally, visualization 640 may need to provide value, security, appropriate access, follow certain design rules and/or guidelines, be sharable, etc. Scaling an entire data pipeline may be something that needs to be done end-to-end (not only at visualization 640). Embodiments described herein for data pipelines may help solve these issues. Note that data engineering may be more complex and more technical as compared to other use-cases (e.g., product management use cases). Even a more general data pipeline orchestration may provide substantial value for customers of an enterprise as well as for and internal data-science activities.

Embodiments may provide a convenient User Interface (“UI”) to configure an analytics use case. Deploying an analytics use case with a specific configuration may mean deploying the whole data pipeline end-to-end in the system landscape. The exact landscape may depend on the data sources (e.g., Cloud Reporting), tools (e.g., Python JUPYTER notebook), and applications (e.g., SAP® DATASPHERE®, SAP™ Analytics Cloud) that are used and may be considered for each analytics use case. Once developed, an analytics use case may be deployed to other engineering team challenges to support enterprise activities and enable data-driven engineering (by configuring the analytics use case according to the target team's requirements). Such an approach may make analytics use cases for data engineering teams a software project which can be maintained in GITHUB® and deployed to various enterprise systems (e.g., a development system, a test system, or a production system) and shared.

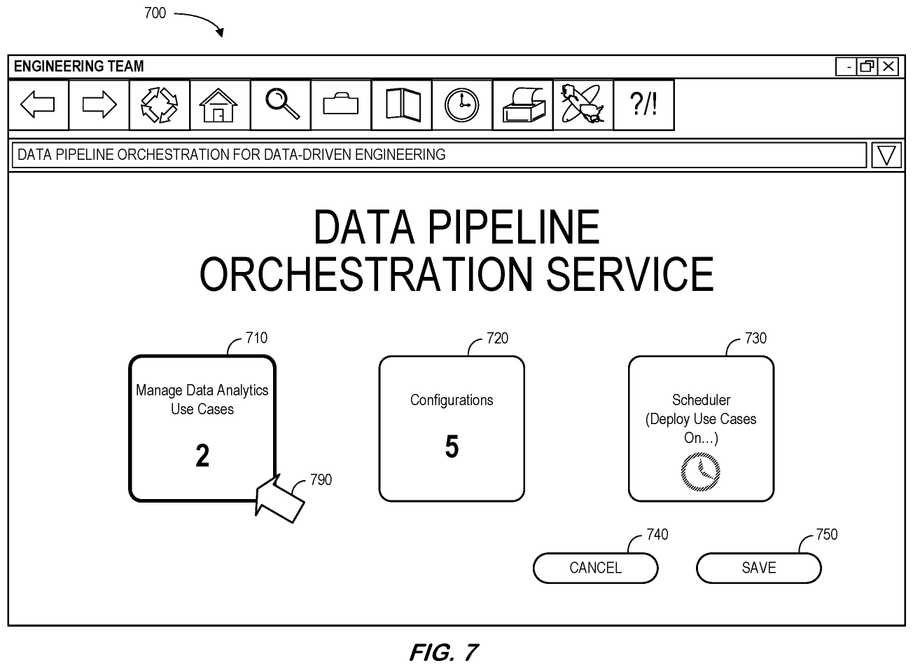

Some embodiments may utilize a design that enables the creation of business applications, such as the SAP™ FIORI® Fiori launchpad, showing multiple applications. For example, FIG. 7 is a data pipeline orchestration service display 700 according to some embodiments. The display 700 includes a “Manage Data Analytics Use Cases” application 710 showing a number of use cases that have been defined (two in the example of FIG. 7). As used herein, the phrase “use case” may refer to a software project that contains coding to deploy a data-pipeline according to a configuration. The display 700 further includes a “Configurations” application 720 and a “Scheduler” application 730. The “Scheduler” application 730 may be used, for example, to define the conditions under which a use case should be automatically deployed. A data engineer can also select to “Cancel” 740 or “Save” 750 changes (e.g., via a touchscreen to computer mouse pointer 790).

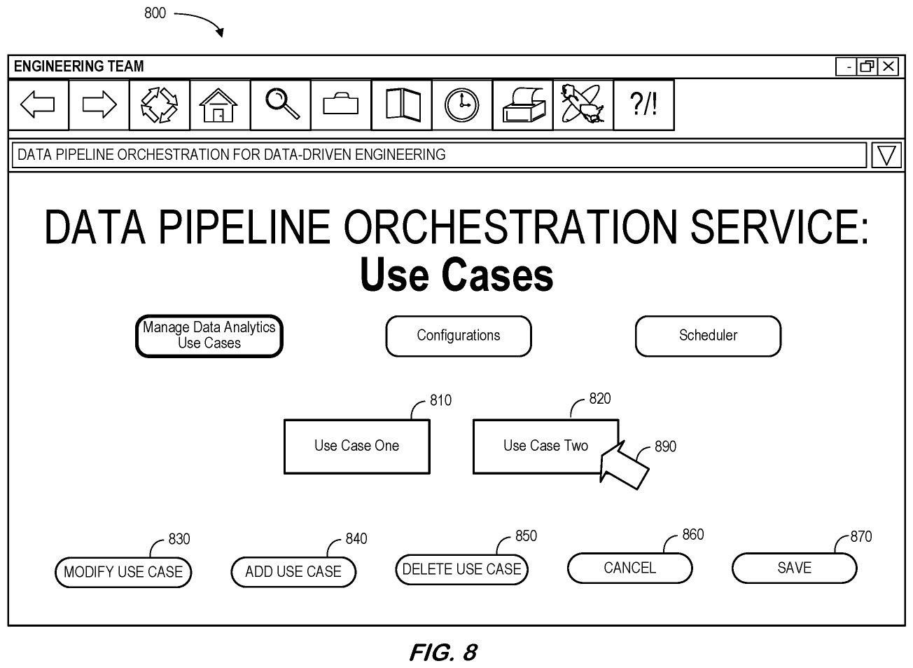

If the data engineer selects the “Manage Data Analytics Use Cases” application 710, another display might be provided. For example, FIG. 8 is a data pipeline orchestration service use case display 800 in accordance with some embodiments. The display 800 includes icons for each of the use cases that have been defined 810, 820. The display 800 further includes a “Modify Use Case” icon 830 which, when selected by a computer mouse pointer 890, lets a user modify a previously define use case (e.g., to adjust it's name), an “Add Use Case” icon 840, a “Delete Use Case” icon 850, a “Cancel” icon 860, and a “Save” icon 870.

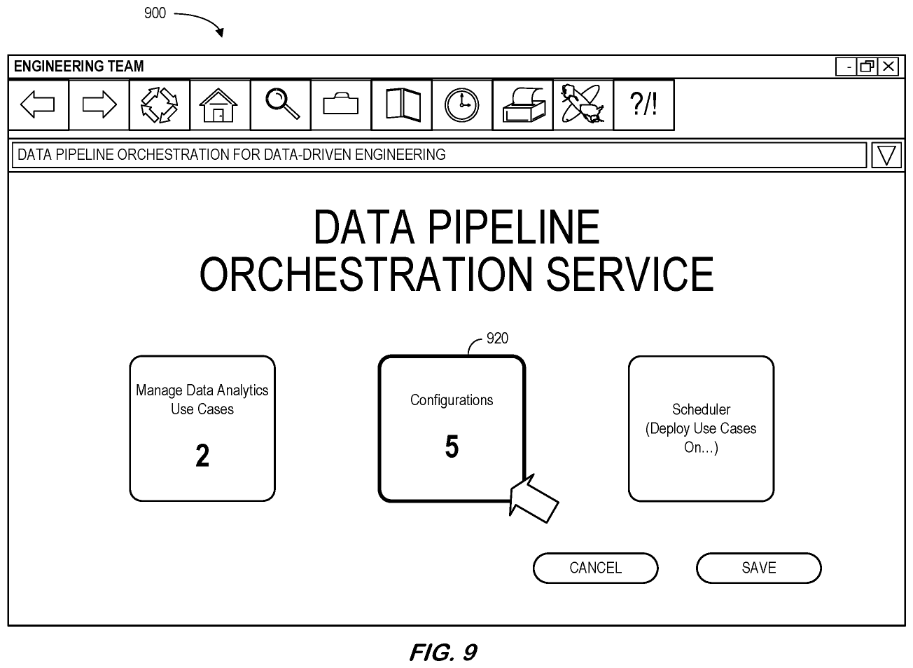

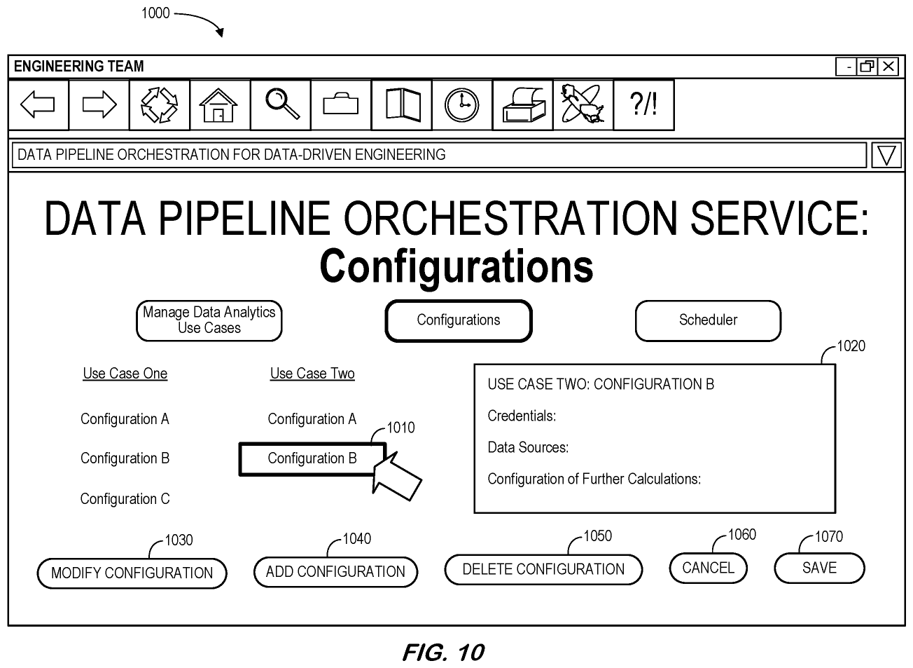

Referring now to FIG. 9, a data pipeline orchestration service display 900 is shown according to some embodiments. If the data engineer selects the “Configurations” application 920, another display might be provided. For example, FIG. 10 is a data pipeline orchestration service configuration display 1000 in accordance with some embodiments. The display 1000 includes a list of configurations 1010 for each defined use case. When a configuration is selected, a configuration definition popup window 1020 is displayed where the data engineer can define credential details, data source mappings, configurations of further calculations, etc. The display 1000 also includes a “Modify Configuration” icon 1030 which lets a user modify a previously defined use case (e.g., to adjust its name), an “Add Configuration” icon 1040, a “Delete Configuration” icon 1050, a “Cancel” icon 1060, and a “Save” icon 1070. The configurations are maintained in the configuration application where the user is presented with a UI (e.g., the display 1000) to provide the requested parameters for a specific use case. Once such a configuration is defined, the data pipeline can be deployed with the help of a scheduler application that defines when a deployment of the data pipeline is triggered or data is updated.

In this way, an engineering team can create their own use case and maintain their own configuration. Engineering teams can also use existing use cases from other teams, which might be shared as GITHUB® projects. Engineers are familiar with GITHUB®, and each use-case can be maintained, forked, discussed, and have its own lifecycle. Note that use cases may consist of “actions” or “pipeline steps” that deploy the data pipeline. For the end-user, these steps might not be visible. The developer of the use case on the other hand may be very involved in defining these actions. The configuration display 1000 feeds each of these actions such that they are executed properly.

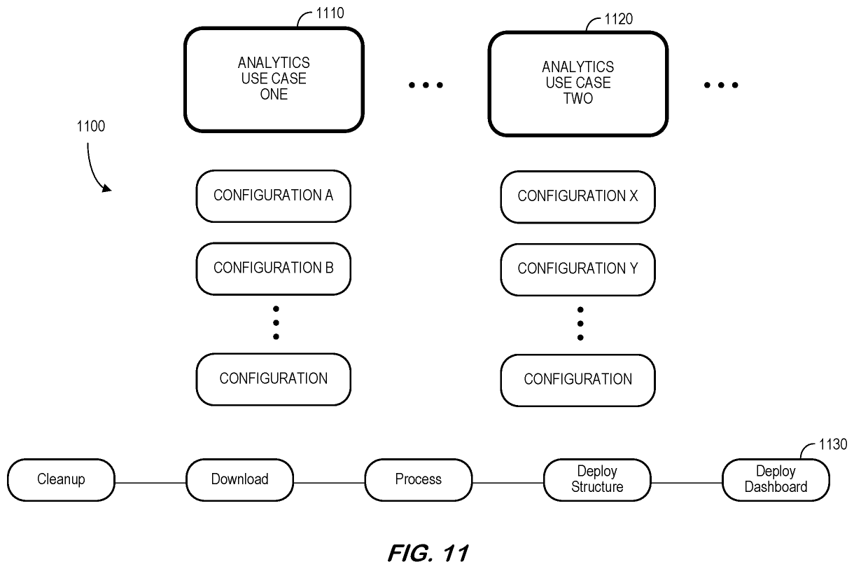

One example of a use case will now be described in connection with FIG. 11 which illustrates a data pipeline hierarchy 1100 according to some embodiments. The hierarch 1100 includes multiple configurations for two data engineering analytic use cases 1110, 1120 (e.g., configurations A, B, etc. for analytic use case one 1110 and configurations X, Y, etc. for analytic use case two 1120). The configurations define a data pipeline 1130 that contains a series of actions. On each of these actions, different data sources, system connections, and activities may be needed. System credentials and all required parameters may all be maintained in the configurations. A cleanup action may prepare data and a download action may connect to the data source and retrieve either all the historic data or the most recent data. This data is further processed using JUPYTER® notebook and/or Pandas. Next, the required structure is deployed into a cloud database. After the structure is deployed, data is uploaded, and a dashboard visualization is also deployed.

For each use case 1110, 1120, multiple configurations can be maintained according to the needs of the engineering teams. When new features or requirements are introduced, new configurations might be needed. A data engineering team might, for example, develop an analytical use case for the Open Data (“OData”) protocol where that extensively analyzes usage data of an OData request. In the beginning, the team might only consider OData Version 2 (“V2”). After OData Version 4 (“V4”) was introduced, the team would maintain a new configuration, which simply switches the data source of the data pipeline. Improving the OData V2 dashboard and OData V4 dashboard only involves maintaining the OData use case.

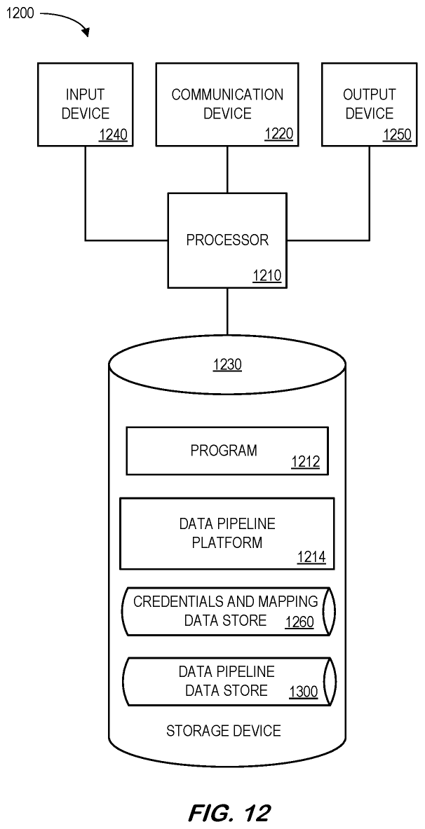

Note that the embodiments described herein may be implemented using any number of different hardware configurations. For example, FIG. 12 is a block diagram of an apparatus or platform 1200 that may be, for example, associated with the system 400 of FIG. 4 (and/or any other system described herein). The platform 1200 comprises a processor 1210, such as one or more commercially available Central Processing Units (“CPUs”) in the form of one-chip microprocessors, coupled to a communication device 1220 configured to communicate via a communication network (not shown in FIG. 12). The communication device 1220 may be used to communicate, for example, with one or more remote user platforms, cloud resource providers, etc. The platform 1200 further includes an input device 1240 (e.g., a computer mouse and/or keyboard to input use case or scheduler rules or logic) and/an output device 1250 (e.g., a computer monitor to render a display, transmit monitoring reports predictions or alerts, and/or create recommendations). According to some embodiments, a mobile device and/or PC may be used to exchange information with the platform 1200.

The processor 1210 also communicates with a storage device 1230. The storage device 1230 can be implemented as a single database or the different components of the storage device 1230 can be distributed using multiple databases (that is, different deployment information storage options are possible). The storage device 1230 may comprise any appropriate information storage device, including combinations of magnetic storage devices (e.g., a hard disk drive), optical storage devices, mobile telephones, and/or semiconductor memory devices. The storage device 1230 stores a program 1212 and/or a data pipeline platform 1214 for controlling the processor 1210. The processor 1210 performs instructions of the programs 1212, 1214, and thereby operates in accordance with any of the embodiments described herein. For example, the processor 1210 may receive, from a data engineering operator, a selection of a data pipeline use case in the data pipeline data store. The processor 1210 may also receive first configuration information for the selected data pipeline use case and second configuration information, different than the first configuration information, for the selected data pipeline use case. The processor 1210 may then store representations of both the first configuration information and the second configuration information in connection with the selected data pipeline use case. Execution of the selected pipeline may then be arranged in accordance with one of the first configuration information and the second configuration information.

The programs 1212, 1214 may be stored in a compressed, uncompiled and/or encrypted format. The programs 1212, 1214 may furthermore include other program elements, such as an operating system, clipboard application, a database management system, and/or device drivers used by the processor 1210 to interface with peripheral devices.

As used herein, information may be “received” by or “transmitted” to, for example: (i) the platform 1200 from another device; or (ii) a software application or module within the platform 1200 from another software application, module, or any other source.

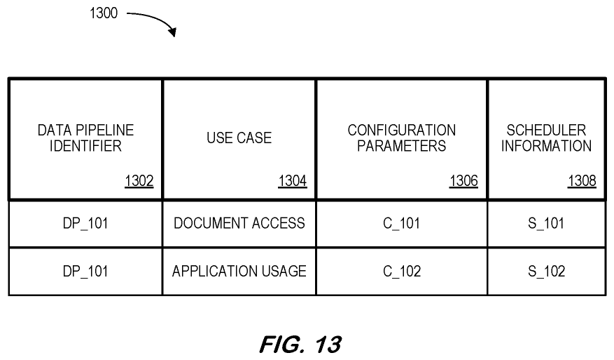

In some embodiments (such as the one shown in FIG. 12), the storage device 1230 further stores aa credentials and mappings data store 1260 and a data pipeline data store 1300. An example of a database that may be used in connection with the platform 1200 will now be described in detail with respect to FIG. 13. Note that the database described herein is only one example, and additional and/or different information may be stored therein. Moreover, various databases might be split or combined in accordance with any of the embodiments described herein.

Referring to FIG. 13, a table is shown that represents the data pipeline data store 1300 that may be stored at the platform 1200 according to some embodiments. The table may include, for example, entries identifying configurations for various data pipeline use cases (e.g., associated with a particular execution environment, operating system, hardware, etc.). The table may also define fields 1302, 1304, 1306, 1308, for each of the entries. The fields 1302, 1304, 1306, 1308 may, according to some embodiments, specify: a data pipeline identifier 1302, a use case 1304, configuration parameters 1306, and scheduler information 1308. The data pipeline data store 1300 may be created and updated, for example, when new data pipelines are added, visualization requirements are changed, data pipeline goals are adjusted, etc.

The data pipeline identifier 1302 might be a unique alphanumeric label or link that is associated with a particular data engineering pipeline to be shared among various enterprise teams. The use case 1304 may describe the type of data pipeline and the configuration parameters 1306 may define how various actions in the pipeline should be performed. The scheduler information 1308 may define when a particular pipeline should be executed or updated.

Thus, embodiments may provide a system and method to improve data information pipeline definition and usage. Once an analytics use-case is developed and its value is evident, the orchestration of data pipelines can be used in order to provide the same value to other engineering team's requirements by simply configuring the use-case according to the engineering team needs. Embodiments may help scale existing visualizations and models in cloud-based computing environment. For example, they may help change a data source of a visualization without clearing a whole dashboard, (which hinders scalability). Similarly, allowing for mode and/or query edits after they are created may improve scalability. As another example, enabling a switch of data sources to other systems to provide a “transport mechanism” may improve the maintainability of artefacts. That is, models and dashboards may not be easily maintainable for large deployments and complex applications with the embodiments described herein. A data pipeline orchestration solution may let an enterprise deploy a data-pipeline first to a test system during development and then later to a production system.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

In some embodiments, specific data pipelines are described. Note, however, that embodiments may be associated with any type of data pipeline. Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of applications and cloud services, any of the embodiments described herein could be applied to other types of applications and cloud services. In addition, the displays shown herein are provided only as examples, and any other type of user interface could be implemented.

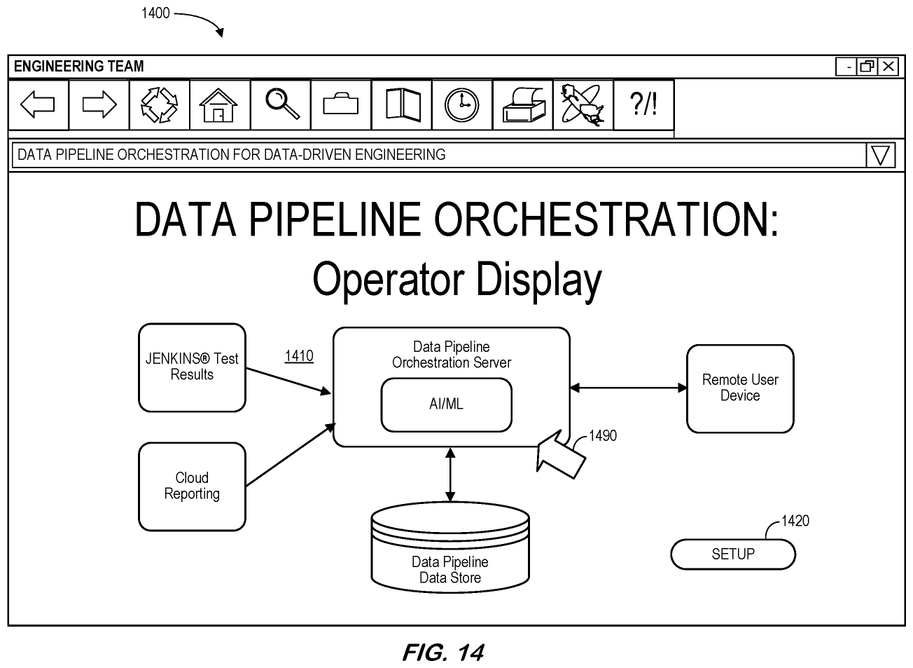

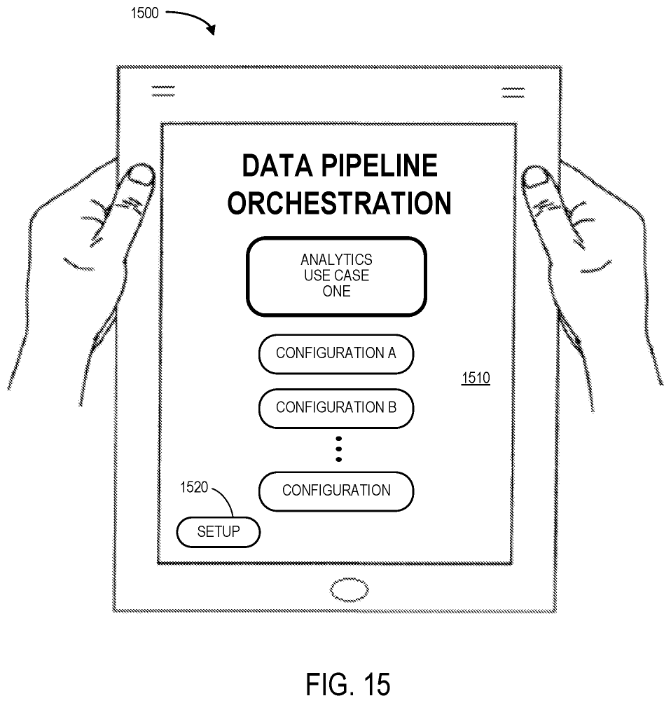

For example, FIG. 14 is a data pipeline orchestration operator display 1400 that represents a Graphical User Interface (“GUI”) that includes graphical representations 1410 of elements of such a system according to some embodiments. Selection of a portion or element of the display 1400 via a touchscreen or pointer 1490 might result in the presentation of additional information about that portion or element (e.g., a popup window presenting a data source or credential details) or let an operator or administrator enter or annotate additional information about a data pipeline (e.g., based on his or her experience and expertise). An “Setup” icon 1420 might initiate such changes. As another example, FIG. 15 shows a tablet computer 1500 rendering a data pipeline orchestration display 1510. The display 1510 may, according to some embodiments, be used to view more detailed elements about components of the system (e.g., when a graphical element is selected via a touchscreen) and/or to configure operation of the system (e.g., to establish new rules or logic for the system via a “Setup” icon 1520).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system associated with data pipeline orchestration, comprising:
a data pipeline data store containing, for each of a plurality of data pipelines, a series of data pipeline steps associated with a data pipeline use case, wherein the series of data pipeline steps include: automatically downloading raw data from an internal enterprise data source; automatically performing extract, transform, load tasks; automatically performing data cleanup; and automatically storing information in a cloud-based data warehouse; and
a data pipeline orchestration server, coupled to the data pipeline data store, including:
a computer processor, and
a computer memory storage device, coupled to the computer processor, that contains instructions that when executed by the computer processor enable the data pipeline orchestration server to:
(i) receive, from a data engineering operator, a selection of a data pipeline use case in the data pipeline data store,
(ii) receive first configuration information for the selected data pipeline use case,
(iii) receive second configuration information, different than the first configuration information, for the selected data pipeline use case,
(iv) store representations of both the first configuration information and the second configuration information in connection with the selected data pipeline use case, and
(v) arrange for an automatic execution of the selected pipeline in accordance with one of the first configuration information and the second configuration information,
wherein a data pipeline use case associated with one data engineering team of an enterprise is shared with another data engineering team of the enterprise via a platform and cloud-based service for software development and version control.

2. The system of claim 1, wherein at least one of the series of data pipeline steps further comprises all of: data cleanup; data processing; deployment of a structure; and data uploading.

3. The system of claim 1, wherein the first configuration information includes information associated with all of: (i) credentials, (ii) data sources, and (iii) configuration of further calculations.

4. (canceled)

5. (canceled)

6. The system of claim 1, wherein the data pipeline use case is deployed to all of: (i) a development system, (ii) a test system, and (iii) a production system.

7. The system of claim 1, wherein execution of the selected pipeline is further performed in accordance with data pipeline scheduler information.

8. A computer-implemented method associated with data pipeline orchestration, comprising:
receiving, at a computer processor of a data pipeline orchestration server from a data engineering operator, a selection of a data pipeline use case in a data pipeline data store, wherein the data pipeline data store contains, for each of a plurality of data pipelines, a series of data pipeline steps associated with a data pipeline use case, wherein the series of data pipeline steps include: automatically downloading raw data from an internal enterprise data source; automatically performing extract, transform, load tasks; automatically performing data cleanup; and automatically storing information in a cloud-based data warehouse;
receiving first configuration information for the selected data pipeline use case;
receiving second configuration information, different than the first configuration information, for the selected data pipeline use case;
storing representations of both the first configuration information and the second configuration information in connection with the selected data pipeline use case; and
arranging for an automatic execution of the selected pipeline in accordance with one of the first configuration information and the second configuration information,
wherein a data pipeline use case associated with one data engineering team of an enterprise is shared with another data engineering team of the enterprise via a platform and cloud-based service for software development and version control.

9. The method of claim 8, wherein at least one of the series of data pipeline steps further comprises all of: data processing; deployment of a structure;
and data uploading.

10. The method of claim 8, wherein the first configuration information includes information associated with all of: (i) credentials, (ii) data sources, and (iii) configuration of further calculations.

11. (canceled)

12. (canceled)

13. The method of claim 8, wherein a data pipeline use case is deployed to all of: (i) a development system, (ii) a test system, and (iii) a production system.

14. The method of claim 8, wherein execution of the selected pipeline is further performed in accordance with data pipeline scheduler information.

15. A non-transitory, computer readable medium having executable instructions stored therein to implement a method associated with data pipeline orchestration, the method comprising:
receiving, at a computer processor of a data pipeline orchestration server from a data engineering operator, a selection of a data pipeline use case in a data pipeline data store, wherein the data pipeline data store contains, for each of a plurality of data pipelines, a series of data pipeline steps associated with a data pipeline use case, wherein the series of data pipeline steps include: automatically downloading raw data from an internal enterprise data source; automatically performing extract, transform, load tasks; automatically performing data cleanup; and automatically storing information in a cloud-based data warehouse;
receiving first configuration information for the selected data pipeline use case;
receiving second configuration information, different than the first configuration information, for the selected data pipeline use case;
storing representations of both the first configuration information and the second configuration information in connection with the selected data pipeline use case; and
arranging for an automatic execution of the selected pipeline in accordance with one of the first configuration information and the second configuration information,
wherein a data pipeline use case associated with one data engineering team of an enterprise is shared with another data engineering team of the enterprise via a platform and cloud-based service for software development and version control.

16. The medium of claim 15, wherein at least one of the series of data pipeline steps further comprises all of: data processing; deployment of a structure; and data uploading.

17. The medium of claim 15, wherein the first configuration information includes information associated with all of: (i) credentials, (ii) data sources, and (iii) configuration of further calculations.

18. (canceled)

19. The medium of claim 15, wherein the data pipeline use case is shared via a platform and cloud-based service for software development and version control and deployed to all of: (i) a development system, (ii) a test system, and (iii) a production system.

20. The medium of claim 15, wherein execution of the selected pipeline is further performed in accordance with data pipeline scheduler information.
